(19) United States
(12) Patent Application Publication
(10) Pub. No.: US 2005/0247080 A1
(43) Pub. Date: Nov. 10, 2005

(54) Method and device for production of a quartz glass blank

(75) Inventors: Hans-Georg Fritsche, Bobbau (DE); Martin Oetzel, Julich (DE); Udo Peper, Lutherstadt (DE); Jurgen Roper, Roitzsch (DE); Malte Schwerin, Queis (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Tenevo GmbH, Hannau (DE)

(21) Appl. No.: 10/525,887

(22) PCT Filed: Aug. 13, 2003
(86) PCT No.: PCT/EP03/08963

§ 371 Date: Mar. 7, 2005

(30) Foreign Application Priority Data
Aug. 27, 2002 (DE) 10240008.3

(51) Int. Cl. C03B 19/14

(52) U.S. Cl. 65/17.4; 65/413; 65/531

(57) ABSTRACT

A conventional method for the production of a quartz glass blank comprises a method step in which SiO₂ particles are generated by means of a series of deposition burners and deposited on a cylinder outer surface of a support, rotating about the longitudinal axis thereof to form a cylindrical porous SiO₂ soot body. The surface temperature of the forming soot body is altered by means of a temperature adjustment body. According to the invention, the above may be developed to give an economical method for the production of an SiO₂ soot body with low axial thickness variations and to provide a device of simple construction of the same, whereby the temperature adjustment body is applied in the form of a planar element running along a significant part of the SiO₂ soot body, which either acts on the soot body surface as a temperature-screening homogeneous heat sink or as a homogeneous reflector for temperature raising, by means of heat radiation. A device suitable for carrying out the above method is characterised in comprising a temperature adjustment body (13), with a planar element acting as a homogeneous heat sink or a homogeneous reflector which runs along a significant part of the SiO₂ soot body (2) and which has a given reflectance for IR radiation.

The present invention relates to a method for producing a quartz glass blank, the method comprising a step in which SiO₂ particles are produced by means of a row of deposition burners and deposited on a cylinder outer surface of a carrier rotating about the longitudinal axis thereof to form a cylindrical porous SiO₂ soot body, the surface temperature of the forming soot body being altered by means of a temperature adjustment body.

Furthermore, the present invention relates to a device for producing a quartz glass blank, comprising a row of deposition burners for producing SiO₂ particles, a carrier which is rotatable about the longitudinal axis thereof and on the cylinder outer surface of which the produced SiO₂ particles are deposited to form a cylindrical porous SiO₂ soot body, comprising at least one temperature adjustment body which is arranged in the area of the forming soot body and which acts on the surface temperature of the soot body for altering the axial density profile thereof.

Quartz glass blanks are used in the form of tubes or rods, especially as semi-products for producing optical components and optical fibers. The axial and radial optical homogeneity of the quartz glass blanks is here a decisive quality criterion. The blanks are obtained by sintering cylindrical porous SiO₂ preforms (“soot bodies”) which are formed by layerwise deposition of SiO₂ particles on a rotating deposition surface by means of a plurality of deposition burners. Only soot bodies with a uniform particle distribution and a narrow density band over their whole longitudinal axis can be processed into high-quality quartz glass blanks.

A method and a device according to the above-mentioned type are known from DE-C 198 27 945. The production of an elongate porous soot body of SiO₂ particles is described therein, wherein SiO₂ particles are deposited in layers by means of flame hydrolysis burners onto a horizontally oriented carrier rod which is rotating about its longitudinal axis. The burners are mounted at an equal distance relative to one another on a burner block extending in parallel with the longitudinal axis of the carrier. The burner block is reciprocated along the forming porous cylindrical soot body between left and right turnaround points by means of a controllable displacement means, the amplitude of said translational movement being smaller than the soot body length. In the area of the turnaround points the soot body surface is overheated, resulting in local axial density variations. To avoid said axial density inhomogeneities, it is suggested in DE-C 198 27 945 that the soot body surface should be cooled actively or passively in the area of the turnaround points. In the case of active cooling, heat is discharged from the soot body surface in the area of the burner turnaround points, e.g. by means of cooling elements or by heat convection or heat flow. In the case of passive cooling, heat sinks are provided in the area of the turnaround points, and these are configured as absorbing surface areas or as slits in a heat shield surrounding the soot body.

Thanks to the heat shield a heat loss in the areas between the turnaround points is reduced and it is promoted in the area of the turnaround points. Hence, these cooling measures have a temperature-reducing effect locally restricted to the areas of the respective turnaround points.

A further method for avoiding temperature peaks in the area of the turnaround points is suggested in DE-A 196 28 958. An overheating of the soot body is here prevented or reduced in the areas around the turnaround points in that the rotational velocity of the forming soot body is increased in said areas, the flame temperature of the deposition burners is reduced, or the distance of the deposition burners from the soot body surface is increased. With these measures an increase in temperature in the area of the turnaround points can be compensated in part or fully and axial density gradients in the soot body can be avoided or reduced.

The known methods have in common that for compensating or avoiding axial density differences high constructional or controlling efforts have to be taken and that the suggested compensating measures are limited to the area of the turnaround points of the burner movement.

However, due to different burner characteristics, due to differences in the burner adjustment or due to misalignments as a result of temperature variations during the deposition process, irregular temperature effects on the soot body are bound to be observed also outside the turnaround points of the burner movement, and thus inhomogeneous density profiles over the longitudinal axis of the porous SiO₂ soot body. Such density variations make it difficult to uphold predetermined quality standards of the quartz glass blank.

As a rule, the deposition process takes place in a deposition chamber within which the row of burners and the soot body as well as the necessary mounting components and lines are arranged, and which is frequently provided with an inspection window. Therefore, due to leakage radiation on differently reflecting surfaces inside the deposition chamber, temperature differences will be observed in the area of the soot body surface also in cases where identical properties of the deposition burners of the row of burners are present, which constitutes a precondition that could hardly be met even if the deposition burners were replaced by a single slit burner extending along the soot body surface.

It is therefore the object of the present invention to provide an inexpensive method for producing an SiO₂ soot body with little axial density variations and to provide a constructionally simple device therefor.

As for the method, this object starting from the method of the above-indicated type is achieved according to the invention in that the temperature adjustment body is used in the form of a planar element extending along a substantial part of the SiO₂ soot body, which either as a homogeneous heat sink has a temperature-shielding effect on the soot body surface or, as a homogeneous reflector, a temperature-raising effect due to heat radiation.

The following formula is in general applicable to the impingement of electromagnetic radiation (light) on a surface:
R+S+A+T=1
where R=reflectance, S=degree of leakage, A=degree of absorption, and T=degree of transmission. In the case of mirror-reflected light, the angle of incidence=angle of emergence, whereas in the case of diffuse-reflected light, the angle of emergence is no longer related with the angle of the incident light.

In the method of the invention, the temperature adjustment body has a planar element which acts either as a homogeneous heat sink or as a homogeneous reflector.

The difference with respect to the known method is that with the planar element it is not the surface temperature of individual discrete portions of the forming soot body that is lowered, but the element acts on the surface temperature over the whole usable length of the body in a homogenizing manner. This effect is achieved in that the planar element is designed as a homogeneous temperature-shielding heat sink or as a temperature-raising homogeneous reflector. In the case of a configuration of the planar element as a reflector, a temperature increase over the whole soot body surface is aimed at by predetermining the reflectance for the IR radiation. This has the consequence that local temperature peaks are evened out, i.e. independently of whether said temperature peaks are created by the burner movement or whether they are due to misalignments or differences between the individual deposition burners or due to leakage radiation.

If the planar element is configured as a heat sink, local temperature increases due to leakage radiation are prevented or avoided in that the leakage radiation is absorbed or dissipated. Hence, this procedure has also the consequence that local temperature peaks are avoided.

To enable the planar element to develop one of these effects, it is configured either as a mirror element (reflector) which homogeneously reflects IR radiation, or as a cooling body (heat sink) which homogeneously absorbs IR radiation. In the first-mentioned case the surface design of the planar element is of essential importance whereas in the second case the material of the planar element additionally influences the cooling function.

The planar element extends over a considerable part of the length of the forming soot body, and its temperature-homogenizing function is fulfilled all the more easily and better the longer the length section of the soot body is that is covered by the planar element. A planar element which is slightly shorter than the soot body can still develop this homogenizing function to an adequate degree over the whole usable soot body length. Therefore, for reasons of clarity, a partial length of more than 50% of the soot body length is still defined as a “substantial part” of said length.

Of importance is the selective adjustment of the reflectance of the planar element with the aim to even out the profile of the surface temperature and thus to homogenize the axial density profile of the soot body. This adjustment of the effect of the planar element by surface or material properties is carried out once at the beginning of a deposition process and will normally also be maintained in the subsequent deposition processes.

In the method of the invention one planar element or several planar elements of equal effect may be used at the same time. It is also possible to use a plurality of planar elements that differ in their homogenization effect with respect to intensity or type (acting as a homogeneous heat sink or as a homogeneous reflector), but it is ensured at any rate that a planar element within the meaning of this invention is used that extends along a substantial part of the SiO₂ soot body. For example, to achieve a lower surface temperature in the area of the ends of the SiO₂ soot body, planar elements may be provided with a different effect than that of the planar element acting on the central area of the SiO₂ soot body within the meaning of the invention.

Preferably, a planar element is used that is formed by an inner wall of a housing surrounding the SiO₂ soot body.

This variant of the method is particularly simple in constructional terms because the SiO₂ soot body is normally deposited in a deposition chamber. In this instance the planar element is integrated into the wall of the deposition chamber, so that it forms the wall itself or part of the wall. In the simplest case the whole inner wall of the housing forms a planar element within the meaning of the invention. It is also important here that the material and surface properties of the wall are set with respect to the functionality to be achieved, namely having a temperature compensating effect over the length of the soot body.

In a first preferred configuration of the method of the invention, the planar element acts as a reflector with a reflectance for IR radiation between 80% and 100%.

It has been found that variations in the surface temperature are particularly efficiently evened out by a planar element reflecting the IR radiation. The surface temperature of the soot body is here raised by means of the reflector to an altogether higher temperature level, with the consequence that the amount of heat to be applied by the deposition burners can be lowered. It is thereby possible to increase the altogether more homogeneous heating of the soot body surface by the inventive planar element at the expense of the more inhomogeneous heating by the deposition burners. Hence, the temperature profile is homogenized on the whole over the length of the soot body. In this configuration of the method, two variants have again turned out to be advantageous.

In the first variant of the method, heat of the deposition burners is reflected by means of the planar element towards the soot body. The planar element is here arranged and configured such that heat emanating from the deposition burners, which are arranged in a row, impinges on the element and said heat is reflected towards the forming SiO₂ soot body. The planar element may e.g. be arranged such that the row of the deposition burners or the rows of the deposition burners extend between the soot body and the planar element. The lost heat emitted by the deposition burners to the rear is thus intercepted by the planar element and directed towards the forming soot body.

In the second variant of the method, the heat of the forming SiO₂ soot body is reflected by means of the planar element towards the soot body.

The heat emitted by the soot body is here intercepted by the planar element and reflected back again towards the soot body. The planar element preferably extends above, next to, or below the soot body in this instance. The flame temperature of the deposition burners is higher than the surface temperature of the soot body. Since the intensity of the temperature radiation is increasing approximately in proportion with the fourth power of the temperature T (in degree Kelvin), a reflection of the flame temperature has a stronger temperature-increasing effect on the soot body than in the variant of the method where the heat emission of the soot body is again reflected back to the body itself.

In a planar element acting as a homogeneous reflector, the temperature profile along the soot body surface is evened out in that part of the heat to be applied on the whole is increased by a more homogeneous heating manner (reflector) at the expense of a rather more inhomogeneous heating manner (deposition burner).

Advantageously, a planar element is here used which has an efficiency, defined as the solid angle covering the forming SiO₂ soot body, of at least 60%.

As an alternative, a procedure has also turned out to be useful in which the planar element acts as a heat sink absorbing IR radiation.

In this variant of the method, the planar element does not have a heating or cooling effect on the soot body surface, but it just prevents or reduces the effect of the basically rather inhomogeneous leakage radiation on the soot body, so that the temperature profile is also evened out.

This effect as a heat sink is also achieved in a preferred variant of the method in which a planar element is used that has a roughened surface with a mean surface roughness Rₐ of at least 10 μm. Due to the roughening of the surface the degree of leakage S is considerably increased. Hence, this procedure increases the amount of diffuse reflection at the expense of the mirror reflection. In addition, heat radiation is eliminated by the specific absorption of the corresponding material.

Such a roughened surface can be adjusted in a particularly simple and inexpensive way by grinding, freezing (etching), blasting or similar surface treatment methods. The mean surface roughness Rₐ is here determined according to DIN 4768.

An equally temperature-homogenizing effect is achieved when use is made of a planar element having a blackened surface.

The absorption degree A is considerably raised by blackening the surface. This procedure reduces or eliminates, in particular, the effect of inhomogeneous leakage radiation, as may e.g. emanate from reflecting surfaces inside a process chamber. The blackening may be provided in addition or as an alternative to a roughened surface. Furthermore, a planar element which acts as a heat sink has turned out to be useful when it is cooled.

Cooling is achieved in that the planar element is brought into contact with a coolant. The coolant may be a cooling gas, a cooling liquid or a cooling body. This variant of the method has the advantage that the temperature and thus the efficiency of the planar element can be varied by means of the coolant for influencing and homogenizing the surface temperature of the soot body within certain limits. The cooling of the planar element may be provided in addition or as an alternative to a roughened surface and/or blackening.

Furthermore, it has turned out to be advantageous when the distance between the planar element and the surface of the forming SiO₂ soot body is kept constant.

This ensures a substantially constant temperature-homogenizing effect of the planar element during the deposition process. The planar element is e.g. shifted with an increasing diameter of the forming SiO₂ soot body in a direction perpendicular to the longitudinal axis of the carrier.

It has also turned out to be particularly useful to move the planar element along the soot body.

This procedure is particularly of advantage in a planar element that extends only over a partial length of the soot body. Moreover, this yields a simplified construction in those cases where a fixed planar element might impede the movement of the row of burners; for instance in an arrangement in which the row of burners extends between soot body and planar element, so that the supply lines of the burner row would have to be guided either through the planar element or extend thereabove. The movement of the planar element can e.g. take place in synchronism with the movement of the deposition burners along the soot body.

In a particularly preferred configuration of the method of the invention, the planar element extends over the whole usable length of the soot body. This configuration of the planar element facilitates the adjustment of a homogeneous temperature distribution. The planar element extends over the usable length or beyond said length. The usable soot body length corresponds to the cylindrical length section of the soot body without tapering portions at the two ends (end caps).

As for the device, the above-mentioned object starting from a device of the above type is achieved according to the invention in that the temperature adjustment body comprises a planar element which acts as a homogeneous heat sink or as a homogeneous reflector and which extends along a substantial part of the SiO₂ soot body and has a predetermined reflectance for IR radiation.

In the device of the invention, the temperature adjustment body comprises a planar element that acts either as a homogeneous heat sink in a temperature-shielding manner or as a homogeneous reflector in a temperature-raising manner due to heat radiation on the soot body surface.

The planar element extends at least over a partial length of the forming SiO₂ soot body. In contrast to the known device, the planar element is configured as a homogeneous heat sink or as a homogeneous reflector with a given reflectance. When the planar element is designed as a reflector, an increase in temperature over the whole soot body surface is aimed at by predetermining the reflectance for the IR radiation. This has the consequence that local temperature peaks are evened out, namely independently of whether said temperature peaks are created due to the burner movement, due to misalignments or differences between the individual deposition burners, or due to leakage radiation.

When the planar element is designed as a heat sink, local temperature increases due to leakage radiation are prevented or reduced in that the leakage radiation is absorbed or dissipated. This procedure has also the consequence that local temperature peaks are avoided.

To enable the planar element to develop one of said effects, it is designed either as a mirror element (reflector) which homogeneously reflects IR radiation and has a temperature-raising effect on the whole, or as a cooling body (heat sink) which homogeneously absorbs IR radiation and has a temperature-shielding effect. In the first-mentioned case the surface design of the planar element is of essential importance, whereas in the second case the material of the planar element also has some influence on the cooling function.

The planar element extends over a substantial part of the length of the forming soot body, its temperature-homogenizing function being all the better fulfilled the longer the length section of the soot body is that is covered by the planar element. Since a planar element which is slightly shorter than the soot body may still show a homogenizing function to an adequate degree, a partial length of more than 50% of the soot body length is still defined as a “substantial part” of said length for reasons of clarity.

Of essential importance is the adjustment of the reflectance of the planar element with the aim to even out the curve of the surface temperature and thus to homogenize the axial density profile of the soot body. This adjustment of the effect of the planar element by surface or material properties is made once at the beginning of a deposition process and is normally also maintained in the subsequent deposition processes.

The temperature adjustment body consists of a single planar element or it is composed of several planar elements. It is also possible to provide a plurality of planar elements which differ from one another in their homogenization effect with respect to intensity or with respect to the type (as a homogeneous heat sink or as a homogeneous reflector), but it is always ensured that one of the planar elements extends along a substantial part of the SiO₂ soot body.

Advantageous developments of the device according to the invention become apparent from the subclaims. Insofar as designs of the device as indicated in the subclaims copy the procedures mentioned in subclaims with respect to the method according to the invention, reference is made to the above comments on the corresponding method claims for a supplementary explanation. The designs of the device according to the invention as mentioned in the remaining subclaims shall now be explained in more detail.

With a planar element that has a concave curvature, the IR radiation can be focused onto the surface of the soot body and the homogenizing effect can thereby be intensified. The planar element is e.g. designed as a concave mirror with a longitudinal axis extending along the soot body, the mirror surface extending around the whole cylinder outer surface of the soot body or a part thereof.

In this configuration of the device, two variants have again turned out to be equally suited.

In the first variant, the concave curvature has a focal point which is located in the area of the row of the deposition burners. With the planar element, the heat of the deposition burner is particularly reflected towards the soot body. The planar element is arranged and designed such that heat emanating from the deposition burners arranged in a row will impinge thereon and said heat will be reflected towards the forming SiO₂ soot body. The planar element may here e.g. be arranged such that the row of the deposition burners or the rows of the deposition burners extend between the soot body and the planar element. The lost heat radiated from the deposition burners to the rear is thus intercepted by the planar element and directed towards the forming soot body.

In the second variant of the device, the concave curvature has a focal point which is located in the area of the forming SiO₂ soot body.

Heat emanating from the soot body is here intercepted by the planar element and reflected back again towards the soot body surface. The planar element extends here preferably above, next to or below the soot body.

A planar element acting as a heat sink is advantageously provided with a cooling device.

The cooling device consists e.g. of a cooling body connected to the planar element or of a flow means by which the planar element can be acted upon with a gaseous or liquid cooling medium. Thanks to the cooling of the planar element its efficiency can be varied within certain limits for influencing and homogenizing the surface temperature of the soot body.

The present invention will now be explained in more detail with reference to embodiments and a drawing, which schematically shows in detail in

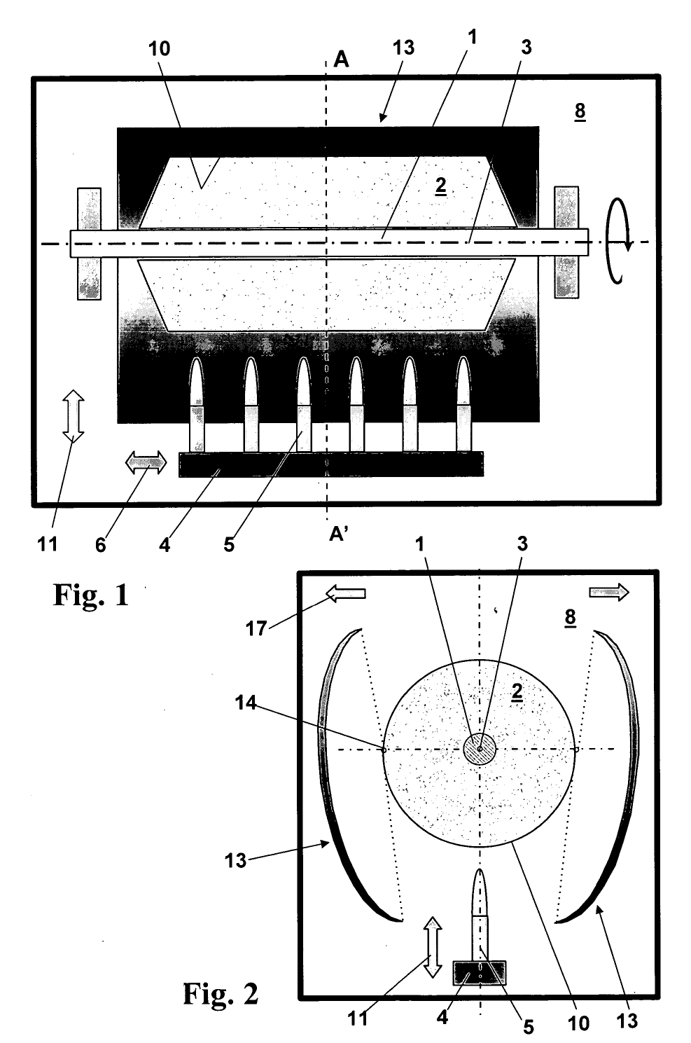

FIG. 1 a longitudinal section through a first embodiment of the device according to the invention with two concave mirrors arranged laterally relative to the soot body, in a front view;

FIG. 2 the device according to FIG. 1 in a section taken along A-A′, in a side view; and

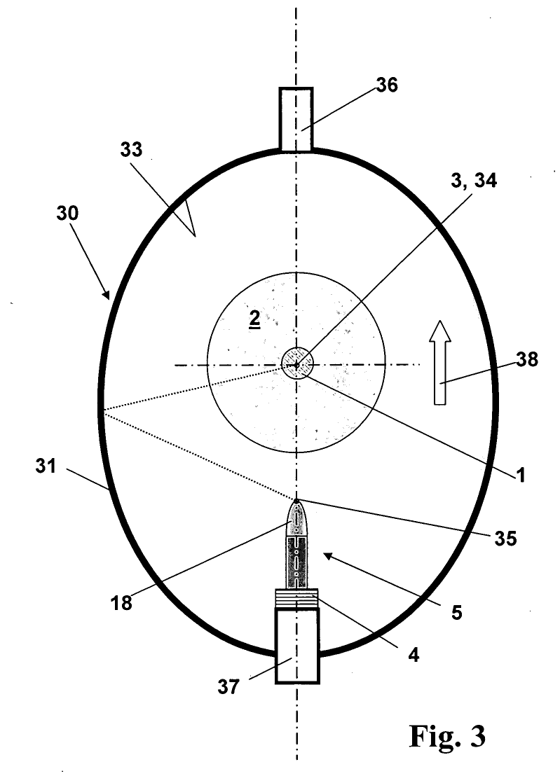

FIG. 3 a second embodiment of the device according to the invention with a cylindrical deposition chamber acting as a concave mirror, in a side vide.

In the device which is schematically shown in FIG. 1, a carrier 1 of aluminum oxide is provided inside a deposition chamber 8, the carrier being rotatable about its longitudinal axis 3 and a porous soot body 2 of SiO₂ particles being produced thereon by means of deposition burners 5. The deposition burners 5 are mounted in a row parallel to the longitudinal axis 3 of the carrier 2 on a joint burner block 4. The SiO₂ particles are deposited by reciprocating the burner block 4 at an amplitude of 20 cm (block arrow 6). The burner block 4 is connected to a drive which effects its reciprocating movement. Each of the deposition burners 5 are fed with burnable gases, oxygen and hydrogen and with vaporous SiCl₄ as the starting material for forming the SiO₂ particles. The distance between the surface 10 of the soot body 2 and the burner block 4 is kept constant in the deposition process. To this end the burner block 4 is movable in a direction perpendicular to the longitudinal axis 3 of the carrier 1, as outlined with directional arrow 11.

With the deposition burners 5, SiO₂ particles are deposited on the surface 10 of the soot body 2 which is rotating about the longitudinal axis 3 of the carrier. The deposition burners 5 are here reciprocated along the soot body surface 10 at identical movement cycles between locally constant turnaround points. The peripheral velocity of the soot body 2 is kept constant at 10 m/min in the deposition process. The mean translational velocity of the burner block 4 is 350 mm/min.

Moreover, the device is equipped with homogeneous planar elements acting as reflectors in the form of two concave mirrors 13 which are opposite each other on the soot body 2 and extend at both sides of the soot body 2 over the whole length thereof. The concave mirror 13 consists of special steel, and the concave inner curvature facing the soot body 2 is each time mirror-finished, whereby its reflectance for infrared radiation is approximately 100%. The concave mirror 13 has a radius of curvature of 400 mm and the distance to the longitudinal axis 3 of the carrier is 270 mm. The focus line 14 (see FIG. 2) of the two concave mirrors 13 extends each time in parallel with the longitudinal axis 3 in the area of the surface 10 of the soot body 2. To keep the focus line 14 with an increasing outer diameter of the soot body 2 in said area, the concave mirror 13 is movable in a direction perpendicular to the longitudinal axis 3 of the carrier, as outlined by the block arrow 17. The efficiency of the two concave mirrors 13, defined as the solid angle covering the forming SiO₂ soot body, is about 80%.

FIG. 2 shows the device according to FIG. 1 in a side view. As can be seen, the concave mirror 13 has an inner curvature which imitates the spatial shape of the forming soot body 2. The concave mirrors 13 extend at both sides of and in parallel with the burner row 4, the minimal distance between the concave mirrors 13 and the soot body surface 10 being kept constant at a value of 100 mm in that the concave mirrors 13 are moved in the direction of the block arrow 17 in the build-up process. The focus line 14 of the concave mirror 13 extends each time in a direction perpendicular to the sheet plane along the soot body surface 10.

The concave mirrors 13 reflect lost heat emanating from the soot body 2 back onto the soot body surface 10, namely over the whole length of the soot body 2. This contributes to a heating of the soot body, whereby variations in the surface temperatures are evened out. It is thus possible to produce a soot body 2 with an axially homogeneous density profile. It has been found that the use of the concave mirrors 13 increases the density of the soot body 2 by 1.5% on average. The increase in density can be compensated by reducing the burnable gases supplied to the deposition burners 5, a reduction of the burnable gases O₂ and H₂ by 5% being required in the embodiment.

In a first alternative embodiment of the device according to the invention the concave mirrors which are opposite each other on the soot body only extend over about 80% of the soot body length.

In a second alternative embodiment the concave mirrors which are opposite each other on the soot body also extend over about 80% of the soot body length and are each extended at both sides beyond the soot body ends by means of special steel elements that have a mat sand-blasted surface. The matted surfaces act in the area of the two soot body ends as a heat sink which leads to a reduction of the density in said areas, as compared with the above-explained first alternative embodiment.

Insofar as like reference numerals as in FIGS. 1 and 2 are used in the embodiment of the device of the invention as shown in FIG. 3, these refer to identical or equivalent components of the device as in FIGS. 1 and 2. Reference is made to the corresponding explanations.

In the device according to FIG. 3, the deposition chamber 30 is designated as an elongate cylindrical concave mirror 31 with an elliptical cross-section which extends along the soot body 2 over the whole length thereof. The concave mirror 31 consists of special steel, and the concave inner curvature 33 facing the soot body 2 is here mirror-finished and has a reflectance for infrared radiation of approximately 100%. An exhaust gap 36 extends at the upper side of the concave mirror 31, and at the lower side thereof an elongate penetration 37 is provided for longitudinally guiding the burner block 4 and for supplying the burnable gases.

The focus lines 34, 35 of the concave mirror 31 extend (in a direction perpendicular to the sheet plane) in parallel with the longitudinal axis 3 of the carrier. The soot body surface 10 is held in the one focus line 34 of the concave mirror 31 (focal point) in that the carrier 1 with an increasing outer diameter of the soot body 2 is shifted upwards in the direction of arrow 38. The burner flames 18 of the deposition burners 5 are positioned on the other focus line 35.

The concave mirror 31 reflects lost heat emanating from the burner flames 18 back to the soot body surface 10, namely over the whole length of the soot body 2. This contributes to a homogeneous heating of the soot body 2, so that the temperature of the deposition burners 5 is lowered accordingly, and the inhomogeneous amount of the heat radiation required for soot formation is thus reduced in favor of an axially more homogeneous heating. Variations in the surface temperature are thus evened out. As a result, it is possible to produce a soot body 2 with an axially homogeneous density profile.

In a constructionally simple variant, the deposition chamber 30 is however configured as an elongate concave mirror with a circular cross-section, as explained with reference to FIG. 3. In this embodiment, the focus line of the concave mirror (the central axis) extends in a direction perpendicular to the sheet plane and in parallel with the longitudinal axis of the carrier advantageously between the burner flames and the soot body surface. The radius of curvature of the concave mirror is 600 mm and its distance to the longitudinal axis of the carrier is 400 mm. The concave mirror designed in this way reflects lost heat emanating from the burner flames back onto the soot body surface, namely over the whole length of the soot body. In comparison with the embodiment of the invention as shown in FIG. 3, this leads, however, to a slightly lower efficiency with respect to the reflection of the heat of the deposition burners onto the soot body surface.

For the explanation of a further variant of the device of the invention, reference is now made to the configuration shown in FIGS. 1 and 2. A planar element is here provided in the form of an upwardly open quarter shell of polished special steel with a reflectance of almost 100%, which shell extends below the whole burner block 4 and by means of which the lost heat of the deposition burners 5 which is emitted downwards is reflected back towards the soot body 2. The quarter shell is firmly connected to the burner block 4 and is reciprocated therewith along the soot body 2, and with an increasing diameter of the soot body 2 it is shifted downwards with the burner block 4 to keep constant the distance between the burner flame and the soot body surface 10.

1. A method for producing a quartz glass blank, said method comprising: a method step in which SiO₂ particles are produced by a row of deposition burners and deposited on a cylinder outer surface of a carrier rotating about a longitudinal axis thereof to form a cylindrical porous SiO₂ soot body, a temperature adjustment body altering a surface temperature of the soot body as it is being formed, wherein the temperature adjustment body comprises a planar element extending along a substantial part of the SiO₂ soot body, which either acts as a homogeneous heat sink and has a temperature-shielding effect on the soot body surface or, acts as a homogeneous reflector, and has a temperature-raising effect due to heat radiation.

2. The method according to claim 1, wherein said planar element is formed by an inner wall of a housing surrounding the SiO₂ soot body.

3. The method according to claim 1, wherein the planar element acts as a reflector with a reflectance for IR radiation between 80% and 100%.

4. The method according to claim 3, wherein heat of the deposition burners is reflected towards the soot body by means of the planar element.

5. The method according to claim 3, wherein heat of the forming SiO₂ soot body is reflected by means of the planar element towards the soot body surface.

6. The method according to claim 1, wherein the planar element has an efficiency, defined as a solid angle covering the forming SiO₂ soot body, of at least 60%.

7. The method according to claim 1, wherein the planar element acts as a heat sink absorbing IR radiation.

8. The method according to claim 7, wherein the planar element has a roughened surface having a mean surface roughness Rₐ of at least 10 μm.

9. The method according to claim 7, wherein the planar element has a blackened surface.

10. The method according to claim 7, wherein the planar element is cooled.

11. The method according to claim 3, wherein the planar element is moved along the soot body.

12. The method according to claim 3, wherein the distance between the planar element and the surface of the forming SiO₂ soot body is kept constant.

13. The method according to claim 1, wherein the planar element extends over the whole usable length of the soot body.

14. A device for carrying out the method according to claim 1, said device comprising: a row of deposition burners for producing SiO₂ particles, a carrier which is rotatable about the longitudinal axis thereof and having a cylinder outer surface on which the produced SiO₂ particles are deposited to form a cylindrical porous SiO₂ soot body, and at least one temperature adjustment body that is supported in an area of the forming soot body and that acts on a surface temperature of the forming soot body for altering an axial density profile, wherein the temperature adjustment body comprises a planar element that acts as a homogeneous heat sink or as a homogeneous reflector and that extends along a substantial part of the SiO₂ soot body and has a predetermined reflectance for IR radiation.

15. The device according to claim 14, wherein the planar element is formed by an inner wall of a housing surrounding the SiO₂ soot body.

16. The device according to claim 14, wherein the planar element has a reflectance between 80% and 100% for IR radiation.

17. The device according to claim 16, wherein the planar element has a concave curvature.

18. The device according to claim 16, wherein the concave curvature has a focal point which is located in an area of the row of deposition burners.

19. The device according to claim 16, wherein the concave curvature comprises a focal point which is located in the area of the forming SiO₂ soot body.

20. The device according to claim 14, wherein the planar element comprises a surface absorbing IR radiation.

21. The device according to claim 20, wherein the planar element is roughened and has a mean surface roughness Rₐ of at least 10 μm.

22. The device according to claim 20, wherein the planar element has a blackened surface.

23. The device according to claim 20, wherein the planar element is provided with a cooling device.

24. The device according to claim 16, wherein the planar element is supported for movement along the soot body.

25. The device according to claim 16, wherein the planar element is made displaceable in a direction perpendicular to the longitudinal axis of the carrier.

26. The device according to claim 14, wherein the planar element extends over the whole usable length of the soot body.
